(19) United States
(12) Patent Application Publication
(10) Pub. No.: US 2008/0065312 A1
(43) Pub. Date: Mar. 13, 2008

(54) GUIDANCE METHOD FOR TEMPORARILY DEVIATING A VEHICLE INITIALLY FOLLOWING A PREDEFINED PATH

(75) Inventors: Francois COULMEAU, Seilh (FR); Guy Deker, Cugnaux (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly-Sur-Seine (FR)

(21) Appl. No.: 11/845,724

(22) Filed: Aug. 27, 2007

(30) Foreign Application Priority Data
Aug. 30, 2006 (FR) 06 07630

(51) Int. Cl. G06F 19/00

(52) U.S. Cl. 701/122

(57) ABSTRACT

The present invention relates to a guidance method for temporarily deviating a vehicle initially following a predefined path. The method is characterized in that the modalities according to which the vehicle leaves the predefined path, accompanied by conditions based on which it rejoins it, are sent to the guided vehicle in the form of an alphanumeric message via a digital data link.

### RELATED APPLICATIONS

The present application is based on, and claims priority from, France Application Number 0607630, filed Aug. 30, 2006, the disclosure of which is hereby incorporated by reference herein in its entirety.

### FIELD OF THE INVENTION

The present invention relates to a guidance method for temporarily deviating a vehicle initially following a predefined path. It applies, for example, to the field of air traffic control.

### BACKGROUND OF THE INVENTION

A flight plan is the detailed description of the route to be followed by an aircraft in the context of a scheduled flight. It comprises in particular a chronological sequence of waypoints described by their position, their altitude and their overflight time. The waypoints constitute the reference path to be followed by the aircraft in order to best observe its flight plan. This reference path is a precious aid both to the ground control personnel and to the pilot, for anticipating the movements of the aircraft and so ensuring an optimum level of safety, in particular in the context of maintaining the criteria of separation between aircraft. The flight plan is routinely managed on board civilian aircraft by a system known as the “Flight Management System”, hereinafter called FMS, which makes the reference path available to the crew on board and available to the other onboard systems. In the interests mainly of safety, it is therefore essential to check that the aircraft follows, at least in geographic terms and, where appropriate, in time terms, the reference path described by the flight plan. For this, the guidance procedures enable the aircraft to be slaved on the reference path. For example, the automatic pilot in “managed” mode generates the manoeuvres based on the reference path made available by the FMS and executes them automatically. This makes it possible to follow, as closely as possible in the three-dimensional space, the path corresponding to the reference path.

However, in some situations, it is preferable, even essential, to deviate from the reference path. For example, the reference path may require the aircraft to cross another aircraft, thus violating the lateral separation criteria. From his ground control centre, the traffic controller responsible for the flight notices the risk in advance because he knows all of the air situation within a wide perimeter around the aircraft he is controlling. He then implements pre-established coordination procedures between the ground and the vehicle, these procedures being routinely grouped together under the English term “Radar Vectoring”. In practice, the controller knows the position of an aircraft that he is guiding by virtue of a radar and it is from this estimated position that he deduces the path that this aircraft should be made to follow. In the present case, these “Radar Vectoring” procedures make it possible, for example, to ensure that two aircraft cross in optimum conditions of safety. They are based on a set of guidance instructions, also predefined, that the controller gives to the pilot. These instructions are improperly grouped together under the English term “clearance”. The pilot manually executes the guidance instructions that he receives one after the other, each time confirming their execution to the controller. For example, the controller initially gives a first instruction which aims to temporarily deviate the aircraft from its reference lateral path by changing its heading. Then, once the crossing has been made in accordance with the separation criteria, the controller subsequently gives a second instruction which aims to return the aircraft to its reference path in the shorter or longer term, by again changing its heading. This example of two instructions is not limiting and a large number of instructions can follow each other until the reference path is actually rejoined.

Until very recently, the instructions were exclusively given orally by VHF radio, the pilot confirming the execution also by speech. The main drawback of this method is that it encourages a lack of understanding and mistakes. The manoeuvre that is executed may then not comply with the instruction given. In this case, the next instruction must correct the lack of accuracy in applying the preceding instruction. The second drawback is that, with the onboard execution procedure being purely manual, the FMS is not notified of the executed manoeuvres and does not therefore update the reference path in the flight plan. Now, communication-dedicated onboard equipment, like the “Communication Management Unit” (CMU), sends the reference path to other parties involved in air navigation by digital data link in order to synchronize the views of the various parties and improve safety. Thus, following the manual execution of a guidance instruction, ground control centres receive a scheduled route broadcast by the CMU which is not quite the one actually followed by the aircraft. Such a situation is highly prejudicial to flight safety.

Since recently, certain instructions have been given via a digital data link in the form of messages in a standard text format. These “clearance” messages can be received and processed by the FMS. They can also be executed directly by the automatic pilot. This method thus avoids one of the drawbacks of the previous method by speech: there is no possibility of misunderstanding and the manoeuvre carried out is always perfectly in accordance with the instruction given by the controller. However, despite the automation of the processing operations on board, this method does in most cases present the other drawback of the method by speech: the reference path in the flight plan is not updated. Because, regardless of the reason, the nature and the number of guidance instructions given by the controller, the aircraft will ultimately rejoin the reference path as described in its flight plan, at least to land at the scheduled airport. Consequently, a path that would only reflect the current flight of the aircraft after applying a guidance instruction, without in addition specifying any destination airport, could not be considered as a reference path usable by the other parties involved in air traffic control, since it would obviously not reflect either the intention of the controller or the intention of the pilot. It would be only a very short term view of the path followed by the aircraft, which is inherently incompatible with the safety constraints that give priority to long term information. Rather than use such a path, it is even better not to update the reference path if a guidance instruction does not specify the conditions for rejoining the reference path of the flight plan, which is unfortunately the case with most guidance instructions. Therefore, only the latest guidance instruction making it possible to actually rejoin the reference path can be incorporated in the flight plan. As long as that latest instruction has not been given by the controller, the FMS cannot anticipate the subsequent decisions of the controller. This is why approximately 95% of the instructions are not processed automatically and continue to be the subject of voice exchanges between the controller and the pilot. They are executed manually on board and are therefore not incorporated by the FMS in the reference path, said reference path being all the same sent as it is by the CMU to the other parties involved in air traffic control on the ground, to the detriment of safety. This recent method based on the sending of digital messages simply reproducing the exchanges of the old method by speech therefore only partially overcomes the drawbacks. By barely reducing the risks of misunderstanding, this method fails to exploit of the data links now available and whose use seems unavoidable in light of the ever increasing levels of saturation of the VHF frequencies.

One of the problems raised lies in the fact that a guidance instruction gives no indication as to the subsequent instructions. In particular, it gives no indication as to what will be the last guidance instruction making it possible to actually rejoin the reference path. Now, the FMS would need the next instruction to determine the short term path and would need the last instruction to determine the long term path. But, for several reasons, there is operationally no point in requiring an entire sequence of instructions. On the one hand, even if the controller has a good idea, from the first guidance instruction that he gives, of the complete manoeuvre that he wants to have the pilot execute, this manoeuvre is likely to change with the operational situation. On the other hand, the guidance instructions were initially standardized in an operational context where the exchanges were conducted by speech only, this type of exchange moreover continuing to be the remedy. In this context, it was necessary to take account of the collation mechanism that must be implemented by the parties, who dialogue on overloaded frequencies in an English language which is often not their own. Indeed, quite often the pilot is not capable of interpreting the instruction immediately as he has heard it, so he must first mentally compare what he has heard with the standard instructions that he knows, in order to find the closest known instruction. It is commonly stated that he “collates” the instruction as he has heard it with a standard instruction. This mechanism, which may seem risky and vague, is paradoxically necessary to the good understanding between the controller and the pilot. To minimize the false collation rate, the pilot repeats to the controller the instruction as he has interpreted it in order for the latter to be able to correct it if necessary. This is what is called “readback” according to the English terminology and this term will be used hereinafter. It should be noted that the collation/readback mechanism is not advisable for solving a problem linked solely to the use of the English language by non-native English speakers, because there are many cases that can be cited of misunderstandings between English-speakers that have led to accidents. More generally, it is supposed to overcome the ambiguities inherent in an indirect voice communication between remote parties. The instructions given by the controller must therefore be short in order to facilitate the collation, and this is why it is not efficient to give a whole sequence of instructions. The mechanism of mental comparison by collation would not be effective and the risks of misunderstanding would be too great despite the readback.

Consequently, executing the guidance instructions on board while incorporating them in the reference path that is broadcasted to the ground control centres has proved to be a complex problem, which the solutions proposed hitherto only partially address.

### SUMMARY OF THE INVENTION

The main object of the invention is to overcome the abovementioned drawbacks by proposing an instruction termination mechanism included in the guidance instruction itself and enabling the FMS to make a path prediction following the execution of the instruction, the prediction concerned being the most reliable possible given the uncertainty that exists on board concerning the intentions of the controller until the latter has given the next instruction. To this end, an object of the invention is a guidance method for temporarily deviating a vehicle initially following a predefined path. The modalities according to which the vehicle leaves the predefined path, accompanied by conditions based on which it rejoins it, are sent to the guided vehicle in the form of an alphanumeric message via a digital data link.

For example, the conditions based on which the guided vehicle rejoins its predefined path can include reaching a point in space or the timing-out of a time delay or even travelling a distance.

When the conditions based on which the guided vehicle rejoins its predefined path are fulfilled, the guided vehicle can rejoin its predefined path by following the shortest path enabling it to converge towards its predefined path at an angle less than or roughly equal to 45 degrees.

In an example of embodiment, the predefined path can be a flight path and/or the vehicle can be an aircraft guided from the ground by an air traffic control centre.

Other main advantages of the invention are that it enables the workload of the air crew to be considerably reduced, with the systematic incorporation by the FMS of the guidance instructions according to the invention into the reference path allowing them to be executed by the automatic pilot in “managed” mode. Moreover, the control centres receive from the CMU a reference path consistent with the actual movements of the aircraft and all the parties involved in flight navigation therefore share a uniform view of the flight for greater safety. In addition, the invention enables the pilot to know his most probable short term path and thus to estimate the time lost or gained in the off-flight plan manoeuvre imposed by the controller.

### BRIEF DESCRIPTION OF THE DRAWINGS

Other characteristics and advantages of the invention will become apparent from the description that follows given in light of the appended drawings which represent:

FIG. 1, an illustration of an example of an operational crossing procedure between two flights in accordance with guidance instructions according to the prior art;

FIG. 2, an illustration of the same example of an operational crossing procedure between two flights, but in accordance with guidance instructions according to the invention;

FIG. 3, a system architecture diagram illustrating an example of implementation of the method according to the invention within an FMS system.

### DETAILED DESCRIPTION OF THE DRAWINGS

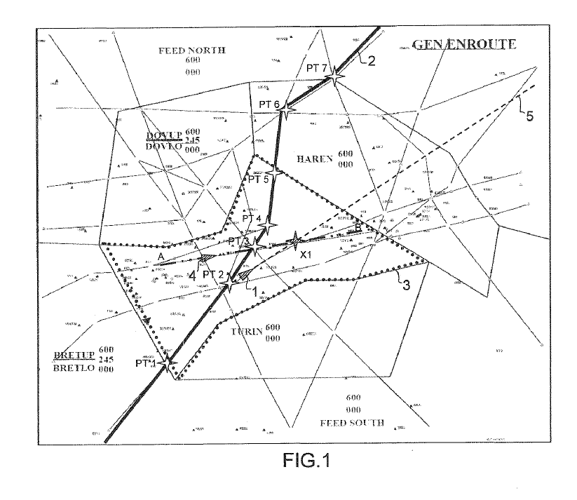

FIG. 1 shows an aeronautical map illustrating an example of an operational crossing procedure between two flights in accordance with guidance instructions according to the prior art given by the controller, and the reference path that can result from this in the flight plan of the deviated aircraft.

An aircraft 1 represented by a triangle initially follows a reference path 2 along a predefined air route. The reference path 2 is defined based on 7 waypoints PT1, PT2, PT3, PT4, PT5, PT6 and PT7, these waypoints having to be flown over in this order respectively. Usually, the waypoints are points of interest. In the example of FIG. 1, the point PT1 is the point of entry of the path 2 into a control sector 3 represented in dotted lines by a 9-sided polygon. The control sector 3 encompasses a geographic area in which the same one traffic controller is responsible for controlling the air traffic. The point PT5 is the point of exit of the path 2 from the control sector 3. The points PT2, PT3, PT4, PT6 and PT7 are crossing points of the air route followed by the reference path 2 with other predefined air routes. These points can be physically marked on the ground by aeronautical beacons. The controller of the sector 3 also has control of an aircraft 4, also represented by a triangle, which follows a segment AB along one of the air routes crossing the reference path 2 of the aircraft 1, in this case at the point PT3. In order to maintain the separation criteria between the aircraft 1 and the aircraft 4, the controller has decided to begin a guidance procedure for the aircraft 1 in order to temporarily deviate it in the vicinity of the point PT3 from its reference path 2. For this, he gives the aircraft 1 a first heading instruction towards a point X1 of the segment AB that he has chosen arbitrarily but that he knows will not be flown over simultaneously by the aircraft 4. His intention is then to give it a second instruction to return to the reference path 2 when it has reached the point X1. All the other symbols and characters represented on FIG. 1 are there only as part of the map of the area used as an example.

In the example of FIG. 1, the controller sends a heading instruction to the aircraft 1 when the latter flies over the point PT2, the instruction being in accordance with the prior art. The instruction can be given by speech or be compliant with RTCA standard DO-219. In this second case, it is represented in the form of a text message “FLY HEADING [300]”, which can easily be digitized for sending by data link and which tells the pilot to fly along the 300 degree heading. On receiving the heading instruction, the pilot therefore manually alters the course of the aircraft 1 by taking the 300 degree heading. The aircraft 1 thus leaves its reference path 2, which is well illustrated by FIG. 1. It can clearly be seen that the giving of such an instruction to change heading cannot give rise to an update of the reference path 2 of the flight path. In practice, the giving of such an instruction to change heading can at most make it possible to estimate a path 5, shown by dotted lines in FIG. 1, that the aircraft will take if it in the long term maintains the 300 degree heading that is dictated in the instruction. Now, as explained previously, the path 5 does not absolutely reflect the intentions of the controller beyond the point X1, the controller having the intention of returning the aircraft 1 to its reference path 2 when the point X1 has been reached. Thus, incorporating the path 5 in the reference path would absolutely not be representative of the future movements of the aircraft 1 and, in the long term, would even be prejudicial to its safety since the points of interest PT4, PT5, PT6 and PT7 would even be falsely considered as no longer having to be flown over by the aircraft 1. Probably, its destination airport would even no longer be on its reference path, creating a route discontinuity. Only on passing the point X1, and if the controller gives an instruction to effectively rejoin the reference path 2, for example a “RESUME ROUTE” instruction according to RTCA standard DO-219 telling the pilot to rejoin the route of his flight path as early as possible, would it be possible to update the reference path 2 in a relevant manner. For example, a predefined strategy to rejoin the reference path as early as possible with a 45 degree interception angle could be applied on receiving the “RESUME ROUTE” instruction. Thus, the updated reference path would indeed reflect the intentions of the controller and the route that the aircraft should follow in the long term, providing in particular a continuous route to its destination airport and including very probably PT5, PT6 and PT7. Unfortunately, as long as no actual instruction to rejoin the reference path is given, it is not possible with the current instructions to update the path in a relevant manner. The reference path 2 therefore remains unchanged as illustrated in FIG. 1, so it is temporarily no longer representative of the path actually followed by the aircraft 1, but is all the same sent as it is to control centres to the detriment of safety.

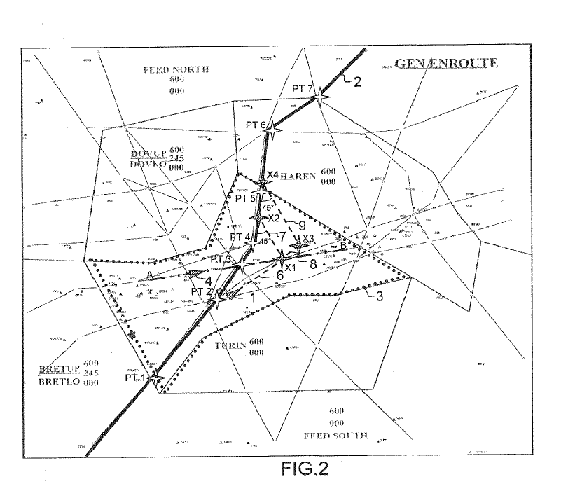

FIG. 2 illustrates the same example of an operational crossing procedure between two flights as that of FIG. 1. However, this time, the crossing takes place in accordance with guidance instructions according to the invention. FIG. 2 also illustrates the reference path which can result from these instructions in the flight plan of the deviated aircraft.

In the example of FIG. 2, the controller also sends a heading instruction to the aircraft 1 when the latter flies over the point PT2, but this time the instruction is in accordance with the invention and includes an instruction termination condition. Drawing from RTCA standard DO-219 introduced previously, such an instruction can advantageously be represented in the form of a text message “FLY HEADING [300] UNTIL [X1]”. Comprising alphanumeric characters, the message can advantageously be digitized for sending by data link. It tells the pilot to fly along the 300 degree heading until he reaches the point X1. On receiving the heading instruction on board, the course of the aircraft 1 must therefore be altered by taking the 300 degree heading. As in the past, the pilot can manually alter the course of the aircraft 1. By virtue of the present invention, the alteration can also be done automatically, for reasons detailed below. The aircraft 1 thus leaves its reference path 2, which is well illustrated by FIG. 2. In the example of FIG. 2, the heading instruction termination condition, that is, the condition based on which the aircraft 1 is no longer obliged to follow the 300 degree heading, is to reach the point X1. It can be assumed that, once the point X1 is reached, the aircraft 1 must rejoin its reference path 2 as early as possible because it is operationally the most probable outcome in light of the termination condition included in the guidance instruction. This termination condition having been given by the controller himself, it at least partly reflects his intentions. It therefore clearly appears that the giving of such an instruction to change heading can this time give rise to a relevant update of the reference path 2 of the flight plan by the FMS. This explains why the instruction to change heading according to the invention can be applied automatically: the FMS can incorporate it in the reference path 2 used by the other systems on board, in particular the automatic pilot.

On receiving the heading instruction and until the aircraft 1 has reached the point X1, the FMS can, for example, compute a direct segment 6 between the current position of the aircraft 1 and the point X1, then compute a segment 7 from the point X1 making it possible to intercept the initial reference path 2 at 45 degrees at a point X2, the point X2 thus being the point of rejoining the initial reference path 2. The FMS can then incorporate the two segments 6 and 7 in the initial reference path 2. At the moment when it receives the instruction and before incorporating the segments 6 and 7, the reference path is denoted in text form “PT2(FROM), PT3(TO), PT4, PT5, PT6, PT7”, the terms between brackets “FROM” and “TO” respectively indicating the last waypoint flown over by the aircraft 1 and the next waypoint to be flown over by the aircraft 1. After the FMS has incorporated the segments 6 and 7 that it has just computed, the reference path 2 becomes “PT2(FROM), X1 (TO), X2, PT5, PT6, PT7”.

In the case where the point of interception of the reference path 2 at 45 degrees from the point X1 would be outside the control sector 3, then the interception could be made with a greater angle of convergence to be sure of passing through the waypoint PT5 before entering into the adjacent control sector. If, in addition, the waypoint PT5 did not exist, it would also be possible to envisage entering into the next control sector at a point X4 on the reference path 2 and at the boundary of the sector 3. In this case, after the new segments had been incorporated by the FMS, the reference path 2 would become “PT2(FROM), X1 (TO), X2, X4, PT6, PT7”.

Immediately after the point X1 has been flown over and as long as no new guidance instruction is received, the FMS can, for example, consider that the aircraft will continue its 300 degree heading along a segment 8 until a point X3, the point X3 corresponding to the furthest point on the 300 degree heading from the point X1 that makes it possible to intercept the reference path 2 before leaving the control sector 3 with a 45 degree angle of incidence. This last part of the flight before rejoining the reference path 2 is well illustrated in FIG. 2 by a segment 9 between the point X3 and the boundary point X4 defined previously. After the segments 8 and 9 have been incorporated by the FMS, the reference trajectory 2 becomes “X1 (FROM), X3(TO), X4, PT6, PT7”. Thus, from the first guidance instruction according to the invention aiming to deviate the aircraft 1 from its flight plan and until it actually rejoins the path of its flight plan, the FMS system on board the aircraft 1 is able to constantly maintain a reference path 2 that is relevant both to the final destination of the aircraft 1 and to the intentions of the controller.

It is important to note that the instruction termination condition of FIG. 2, which is to reach the point X1, is given only as an example and many other types of instruction termination conditions can be envisaged. For example, in the case of the instruction to change heading of FIG. 2, it can be a flight time and the guidance instruction according to the invention can then advantageously be “FLY HEADING [300] DURING [5]” drawing on RTCA standard DO-219. This tells the pilot to fly along the 300 degree heading for 5 minutes. Still in the case of the instruction to change heading of FIG. 2, it can also be a flight distance and the guidance instruction according to the invention can then advantageously be “FLY HEADING [300] FOR [10]”. This tells the pilot to fly along the 300 degree heading for 10 nautical miles. And for other types of instructions, the instruction termination condition must also be adapted.

If we consider the “RESUME ROUTE” instruction defined by RTCA standard DO-219 and which makes it possible to return an aircraft to the route of its flight plan as early as possible, to introduce the concept of instruction termination as the invention does, can for example make it possible to consider that the “RESUME ROUTE” instruction is the default instruction when the aircraft is no longer on its path and it has not very recently received a guidance instruction, the instruction termination condition making it possible to determine the moment from which the default “RESUME ROUTE” instruction can be applied. In the example of FIG. 2, applying the “RESUME ROUTE” instruction consists in rejoining the point labelled “TO” of the reference path 2, by applying a rule according to which the angle of penetration of the reference path must be less than 45 degrees. However, this default “RESUME ROUTE” instruction cannot be applied until the point X1 has been reached. It is important to note that other strategies for rejoining the reference path can be implemented.

In the example of FIG. 2, the controller gives no second instruction at all after the initial heading instruction, this in order to clearly highlight the effectiveness of the invention even in an extreme case. However, it would be possible to envisage the controller giving one or more other guidance instructions. For example, on passing the point X1, the controller could give the instruction “DIR TO [PT5]”, once again according to RTCA standard DO-219. In this case, the aircraft 1 would have to rejoin its reference path 2 at the waypoint PT5 for an immediate transfer of control to the adjacent sector. Its reference path would become “X1 (FROM), PT5(TO), PT6, PT7”. Thus, a guidance instruction according to the invention also fits very well into a complex guidance procedure and enables the controller to give exactly the same sequences of instructions as previously.

The example of FIG. 2 is that of an aircraft guided from an air traffic control centre, but the method according to the invention is applicable to any type of vehicle following a predefined path, whether it is a land vehicle, a surface vessel or even a submarine vessel, from the moment that it is supervised. Thus, a bus can be deviated from an operations centre, a cargo vessel can be deviated by a maritime controller and a submarine can be deviated by its home base. Only the type of the modalities for the vehicle to leave the path and the type of the conditions based on which it rejoins it are adapted to each vehicle type.

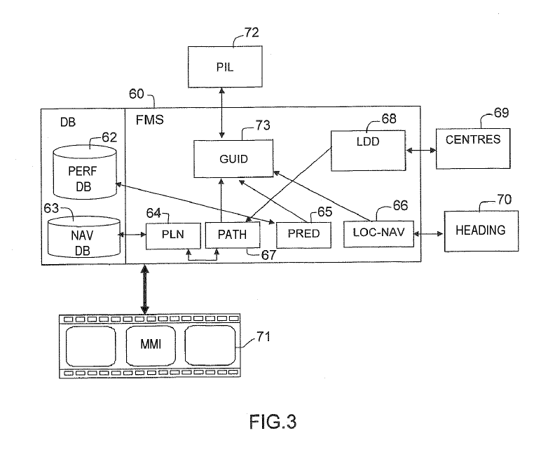

FIG. 3 is a diagram illustrating an example of a system architecture with which to implement the method according to the invention within an FMS system 60. A digital data link module 68 receives guidance instructions from ground control centres represented by a module 69, for example the heading instruction of the examples of the preceding figures. The module 68 supplies these guidance instructions to a path computation module 67. The module 67 also receives the flight plan from a flight plan management module 64, the module 64 converting the aeronautical beacons describing the flight plan using a navigation database 63. It is the module 67 which implements the method according to the invention and which updates the reference path according to the last instruction received from the module 69, as for the path 2 of the preceding examples. The path computation module 67 sends to a guidance module 73 this updated reference path. A location and navigation module 66 supplies the module 73 with the instantaneous kinematic characteristics of the aircraft in terms of position, altitude and speed. The module 66 itself receives raw data from a module 70 combining sensors, of the satellite positioning beacon type and/or of the inertial unit type. A prediction module 65 supplies the module 73 with the predicted times of passage at the points marking out the path to be followed, these points determining the timetable, and the predicted points of kinematic change. To perform its calculations, the module 65 receives the aircraft performance data from a database 62.

Based on the reference path to be followed supplied by the module 67, the timetable supplied by the module 65 through the predicted times of passage at the points and based on the instantaneous kinematic characteristics of the aircraft supplied by the module 66, the module 73 determines the most appropriate commands for the aircraft to follow the reference path. These can be supplied to a piloting module 72 for automatic application. If necessary, the commands can also be displayed on a man-machine interface module 71 for manual application.

The invention described above is fairly inexpensive to implement in existing FMS systems. In practice, it reuses many of the path computation functions already implemented in these systems. At display level, the existing display functions already cover the quite conventional requirements of the invention. Only the modules for receiving and decoding messages require a fairly significant update for exhaustive coverage of all the guidance instructions. In particular, the invention does not require the integration of any new subsystem. Finally, the validation scenarios can be limited to testing the automatic processing of sequences of text messages. Thus, validation itself lends itself to automation.

1. A guidance method for temporarily deviating an aircraft initially following a predefined flight path, the modalities according to which the aircraft leaves the predefined flight path, accompanied by conditions based on which it rejoins it, being sent to the aircraft, wherein these modalities are sent from the ground by an air traffic control center to the guided aircraft in the form of an alphanumeric message via a digital data link.

2. The guidance method according to claim 1, wherein the conditions based on which the guided vehicle rejoins its predefined path include reaching a point in space (X1).

3. The guidance method according to claim 1, wherein the conditions based on which the guided vehicle rejoins its predefined path include the timing-out of a time delay.

4. The guidance method according to claim 1, wherein the conditions based on which the guided vehicle rejoins its predefined path include travelling a distance.

5. The guidance method according to claim 1, wherein, when the conditions based on which the guided vehicle rejoins its predefined path are fulfilled, the guided vehicle rejoins its predefined path by following the shortest path enabling it to converge towards its predefined path at an angle less than or roughly equal to 45 degrees.
